(19) United States
(12) Patent Application Publication
(10) Pub. No.: US 2014/0054244 A1
(43) Pub. Date: Feb. 27, 2014

(54) FILTERING CHIP CONVEYOR

(71) Applicant: Jamie David Towers, Pontefract (GB)

(72) Inventor: Jamie David Towers, Pontefract (GB)

(73) Assignee: LNS MANAGEMENT SA, Orvin (CH)

(21) Appl. No.: 14/002,767

(22) PCT Filed: Mar. 3, 2011
(86) PCT No.: PCT/EP2011/053240

§ 371 Date: Nov. 13, 2013

(51) Int. Cl. B23Q 11/10

(52) U.S. Cl. CPC B23Q 11/1069
USPC 210/767; 210/257.1

(57) ABSTRACT

A filtering chip conveyor comprises: a conveyor tank arranged to retain a cutting fluid containing chips; and a continuous hinge belt at least party disposed inside the conveyor tank, the belt being arranged to rotate and to make turns at a tail end and at a discharge end, leaving a space between an upper flight and a lower flight of the belt. The chips are arranged to be transported by the belt to the discharge end to be discharged off the conveyor. The conveyor further comprises at least one filter box for filtering the cutting fluid that is to be discharged off the conveyor through the filter box. The filter box comprises a filter plate having photo etched or chemically milled orifices having a minimum aperture dimension of less than 0.3 mm and an open proportion of at least 15%.

### TECHNICAL FIELD

The present invention relates to a chip conveyor for conveying cutting chips that are produced in the operation of a machine tool, such as a lathe or the like. More specifically, the proposed conveyor is used for removing different types of chips contained in a coolant fluid and/or cutting oil used in machine tools during metal working. The invention equally relates to a corresponding method of removing chips from a coolant and/or cutting oil.

### BACKGROUND OF THE INVENTION

In normal operation, a machine tool, such as a lathe, produces waste material that should be removed from the workpiece being machined. In these cases, the waste material that is removed from the workpiece is generally removed in various sizes including small pieces that are generally referred to as chips. These chips mix with the oil used in the machining process. The oil can be used for cooling, wash down and/or lubrication, for example. This mixture of cutting fluid and cutting chips enters the conveyor used for removing the chips from the oil. The cutting chips are thus conveyed from the receiving position to a discharge position.

The cutting oil drains through the conveyor to the machine tool oil/coolant reservoir. Some of the chips that are mixed with the cutting oil also pass into the machine's oil/coolant reservoir with the cutting oil. These chips eventually build up in the machine oil/coolant reservoir and require manual intervention to clean them out, because the oil in the reservoir is generally re-circulated for further use. However, before the oil can be recirculated and reused, the waste material produced during the operation of the machine tool first has to be removed.

Hinge belt conveyors are widely used to convey the chips away from the coolant/cutting oil, referred to hereinafter as cutting fluid. This type of conveyor is the most simple of all conveyors on the market, and is widely used throughout the industry. This is a very versatile product in that it is capable of taking any chip shape or size, but has one major drawback in that it does not offer any filtration. This results in small chips passing through the conveyor into the cutting fluid tank which then means that the machine operator has to perform regular maintenance to clean out the tank (duration depending on the specific application).

Self-cleaning scraper conveyors are also known, and they can filter out particles (chips) down to a particle size of around 500 μm (0.5 mm). The minimum dimension of the particles which can be filtered out of the fluid is also referred to as the filtration level. Such conveyors typically use a self-cleaning filter box to prevent small chips (larger than the filtration level of the filter screens used) from passing out of the cutting fluid tank and being cycled back into the machine tool. One problem with such self-cleaning scraper conveyors is that do not filter long chips well, especially long chips having a smallest dimension (thickness) similar to the size of the openings in the filter material. Long chips are liable to become wedged in the weave of typical woven filtration meshes, and are difficult for the scrapers to dislodge. The mesh becomes clogged, and the fluid flow through the screen, and thereby the filtration performance, is markedly reduced. This is one of the reasons why self-cleaning scraper conveyors are commonly supplemented with a filter drum. This combination is better suited to applications in which a wide variety of various chip sizes and shapes are produced and in which filtration is needed.

Machines today are capable of many types of machining processes and thus produce a wide range of chip types and shapes. The currently available solutions are either inefficient (no filtration) or very expensive, due to the complexity of the drum filter and self-cleaning scraper conveyor arrangements required.

It is also possible to reduce costs by having just one belt but with a filter drum. There are problems experienced with this design due to the drum incorporation which means that chips accumulate between the belt. US patent application publication 2002/0166808 discloses a “false bottom” to the conveyor to enable these chips between the belt to be removed.

A self-cleaning scraper conveyor which makes use of a perforated plate for filtering the cutting fluid is known from international patent application WO2004/054758, which describes a chip-separating conveyor in which the chips and the fluid are discharged on to a hinged belt conveyor passing over a partition plate. The larger chips, and many of the smaller chips, are retained on the hinged belt and carried away to the chip discharge end of the conveyor. Some of the chips, especially the smaller chips, pass between or around the hinged plates of the conveyor belt and are caught on a partition plate which runs underneath the upper belt for its whole length (from tail end to discharge end). The partition plate ensures that the chips which pass through or around the upper belt are retained on the partition plate and swept by brushes along the plate towards the discharge end. Any chips which fall off the partition plate are caught on the inner (upper) surface of the return belt, which is equipped with brushes arranged to transport the chips around the upturn at the tail end and then to sweep them on to the partition plate, and thence along the partition plate towards the discharge end. Any chips which fall beyond the around, through or between the hinged plates of the lower (return) belt are collected by brushes on the outer surface of the belt. These outer brushes are designed to sweep these chips around the tail end of the tank and retain the chips on the outer surface of the upper part of the belt as it proceeds to the discharge end of the conveyor. In addition, the inner brushes may also be arranged to sweep across the upper and/or lower perforated filter in order to keep the plate(s) from clogging.

The conveyor of WO2004/054758 is complicated in construction, in that the various brushes and hinged plates must be designed and adjusted to collect and retain the chips in at least four different ways (on the upper belt, on the partition plate, on the lower belt and on the floor of the tank). The use of a partition plate to transport the smaller chips is an additional complication, adding to the cost and weight of the conveyor, and providing extra surfaces and corners where chips or sludge can accumulate, and which require regular cleaning. Furthermore, perforated screens, such as those used in WO2004/054758, are perforated by die-stamping, which produces imperfectly shaped and irregularly-sized orifices, usually with burring around the perforations. The mechanical perforation process also imposes limits on the size and distribution of holes which can be made in a given area, and for a given plate thickness. While perforated filter plates are easier to keep clean by brushing/scraping than woven mesh screens, because of their relatively even planar surfaces, they have the disadvantage that they offer a low fluid through-flow and therefore a low filtering performance.

### SUMMARY OF THE INVENTION

According to a first aspect of the invention, there is provided a filtering chip conveyor comprising: a conveyor tank arranged to retain cutting fluid containing chips, a continuous conveyor belt at least partly disposed inside the conveyor tank, the belt being arranged to rotate and to turn at a tail end and at a discharge end, with a space between upper and lower flights of the belt, so as to transport chips on the upper flight towards the discharge end, to be discharged off the conveyor, at least one filter box arranged between the upper and the lower flights of the belt, at least one filter plate arranged in the filter box, the filter plate comprising a filtration region having a plurality of openings for permitting cutting fluid to pass through the filter plate while not permitting chips whose smallest sectional chip dimension is larger than a predetermined maximum chip dimension, to pass through the filter plate, the at least one filter plate having a thickness of less than 0.3 mm, and the openings include an array of profiled orifices etched through the filter plate, the etched orifice profile being such that the smallest sectional aperture dimension of each orifice is less than 0.3 mm, and such that the sum of the aperture areas of the orifices in the array is at least 18% of the total plate area of the array.

The term “smallest sectional chip dimension” is used here to mean the smallest dimension of each chip which would prevent it from passing through the orifice.

A filter plate can be arranged in an upper surface of the filter box and/or in a lower surface of the filter box.

According to a variant of the invention, the filter plate or plates is/are retained in a frame under lateral tension.

According to a variant of the invention, each of the etched profiled orifices has a straight-through profile, substantially orthogonal to the plane of the filter plate, the straight-through profile extending over at least a portion of the thickness of the filter plate.

According to an alternative variant of the invention, each of the etched profiled orifices has a flared profile portion, flaring from a waist region of minimum aperture area to one of the filter plate surfaces, the flared portion extending over at least a portion of the thickness of the filter plate.

The waist region may be located in a plane intermediate to the thickness of the filter plate, or at one of the surfaces of the filter plate. In particular, the waist region may be at or near the upper (inner) surface of the filter plate, such that the orifices are flared downwards/outwards. This ensures that particles which pass through the waist region can then pass easily through the remainder of the extent of the orifice. Flaring of the orifices on the upper (inner) side of the plate, on the other hand, allows particles which are just too big to pass through the aperture to be trapped in the orifice, without clogging the orifice, in such a manner that they can easily be brushed out by one or more brushing/wiping elements arranged to pass across the plate surface as the belt rotates.

According to a further variant of the invention, the conveyor comprises backwashing means for inducing a flow of cutting fluid through the profiled orifices in a direction counter to the direction of flow of the cutting fluid through the orifices during filtering.

The backwashing means may comprise a positive pressure generating means for increasing the pressure at the orifices of cutting fluid within the filter box to be greater than the pressure of cutting fluid outside the filter box. The backwashing means is adapted to induce one or more positive pressure pulses in the cutting fluid within the filter box such that a backwashing of the orifices is achieved without significantly interrupting the flow of cutting fluid in the filtration direction.

A further object of the invention is to provide a method of removing chips from a cutting fluid using a filtering chip conveyor, the filtering chip conveyor comprising a conveyor tank arranged to retain the cutting fluid containing chips, a continuous conveyor belt at least partly disposed inside the conveyor tank, and a filter box arranged between upper and lower flights of the belt such that upper and/or lower surfaces of the filter box are wiped by at least one wiper element arranged on the inside of the continuous conveyor belt, the filter box being provided with a filter plate having a thickness of less than 0.3 mm, the filter plate being arranged to be wiped by the said wiper elements, the step of providing the filter plate including a step of photo-etching or chemically milling an array of profiled orifices in the filter plate, such that the etched profiled orifices each have a minimum aperture dimension of less than 0.3 mm, and such that the sum of the aperture areas of the orifices in the array is at least 18% of the total plate area of the array.

According to a variant of the method of the invention, the method comprises a step of mounting the filter plate to the filter box such that the filter plate is held in tension when the filter plate is wiped by the wiper elements.

The minimum aperture size is advantageously arranged to be between 0.1 mm and 0.2 mm, with a plate thickness of between 0.1 mm and 0.2 mm.

The proposed product is designed to be a simple filtration conveyor that can handle a multiple range of applications, material and chip types. Furthermore, brushes and/or wiper blades can be attached to the belt so that the filter box can be effectively cleaned as will be explained later on in more detail. In this manner the conveyor becomes self-cleaning.

### BRIEF DESCRIPTION OF THE DRAWINGS

Other features and advantages of the invention will become apparent from the following description of non-limiting exemplary embodiments, with reference to the appended drawings, in which:

FIG. 1 is a perspective view of the filtering chip conveyor according to an embodiment of the present invention;

FIG. 2 is a cross-sectional view of the conveyor taken along line II-II of FIG. 1;

FIGS. 3A to 3E show examples of some preferred geometries of the etched profiled orifices of the invention;

FIG. 4 is a side view of the conveyor illustrating in more detail one part of the conveyor according to an embodiment of the present invention;

FIG. 5 is a side view of the tail end of the conveyor illustrating the configuration of the cleats;

FIG. 6 is a side view of the tail end of the conveyor illustrating another configuration of the cleats;

FIG. 7 is a perspective view of the filter box in accordance with an embodiment of the present invention; and

FIG. 8 is a simplified side view of the conveyor in operation.

### DETAILED DESCRIPTION OF AN EMBODIMENT OF THE INVENTION

Next an embodiment of the present invention is described in more detail with reference to the attached figures.

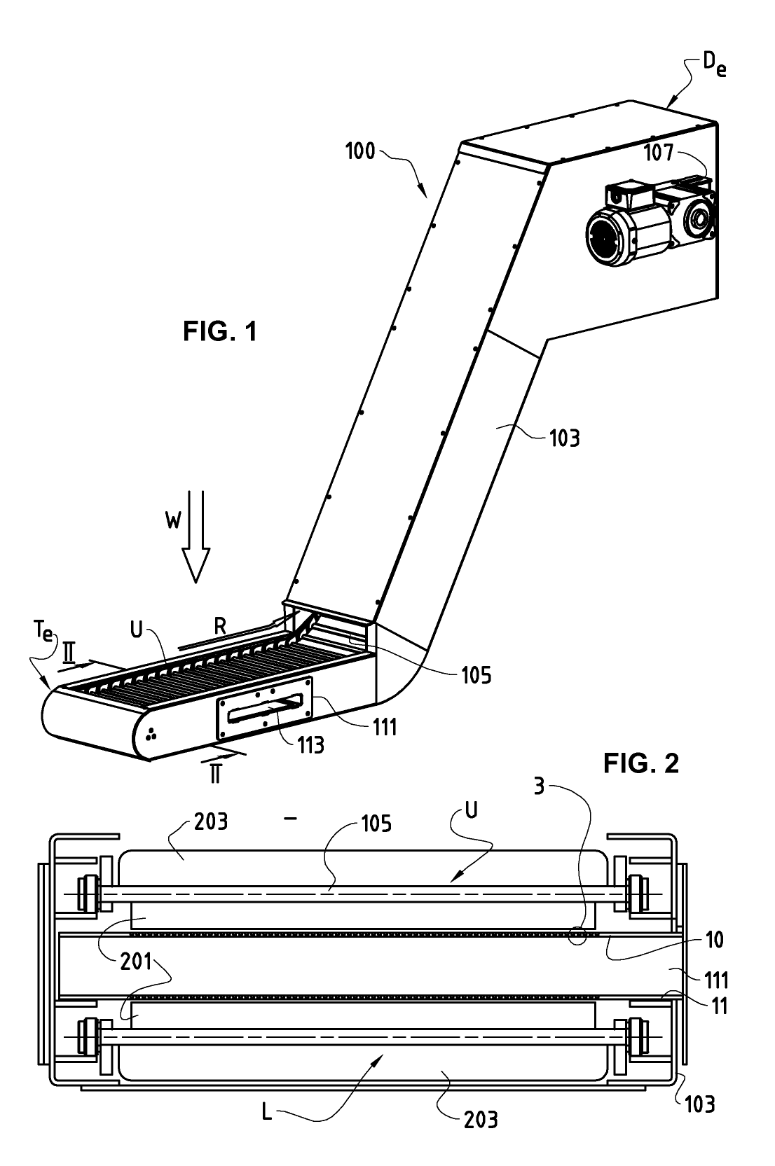

FIG. 1 is a perspective view showing the filtering chip conveyor 100 according to an embodiment of the present invention. The conveyor 100 comprises a conveyor tank 103 that is arranged to retain the dirty cutting fluid resulting from metal working. A conveyor belt 105, in this case a hinge belt, is at least partly disposed inside the conveyor tank 103. The hinge belt 105 is formed by connecting a plurality of metal plates with hinges into a continuous or endless caterpillar-type belt. The chips resulting from the metal working are arranged to fall inside the conveyor tank 103 from the above, in the direction of the arrow W.

The hinge belt 105 is arranged to be turned around a tail-end sprocket/disk 401 (shown in FIG. 5) and discharge end sprockets (not shown in the figures) and rotated as a belt conveyor. In the figures the tail end is referred to by “Te” and the discharge end by “De”. A motor 107 is also shown and is used for rotating the belt 105.

The path of travel of the belt is substantially horizontal in the lower part of the conveyor 100, as can be seen in the figures. The belt has upper (reference “U”) and lower (reference “L” shown in FIG. 2) portions substantially parallel to one another in the lower part of the conveyor 100. The upper portion travels in a first direction, whereas the lower portion travels in a second direction, the second direction being opposite to the first direction, in the lower portion of the conveyor 100. The arrow R in the figures shows the direction of rotation of the belt 105. The upper portion is arranged to carry the large chips to the discharge end De to be discharged off the belt 105. A chip reservoir (not shown in the figure) is used to store the discharged chips.

In FIG. 1, there is also shown a filter box 111 on the inside of the belt, i.e. between the upper U and lower L portions of the belt 105 for filtering the cutting fluid. By placing the filter box 111 on the inside of the belt 105 the filter box 111 is protected from large chips to prevent the problems experienced with the scraper conveyor. As illustrated by the figure, the filter box 111 has an opening 113 on the vertical side wall through which the filtered cutting fluid can be drained to a clean cutting fluid reservoir (not shown). From the clean cutting fluid reservoir the filtered cutting fluid can be pumped to the machine tool for reuse.

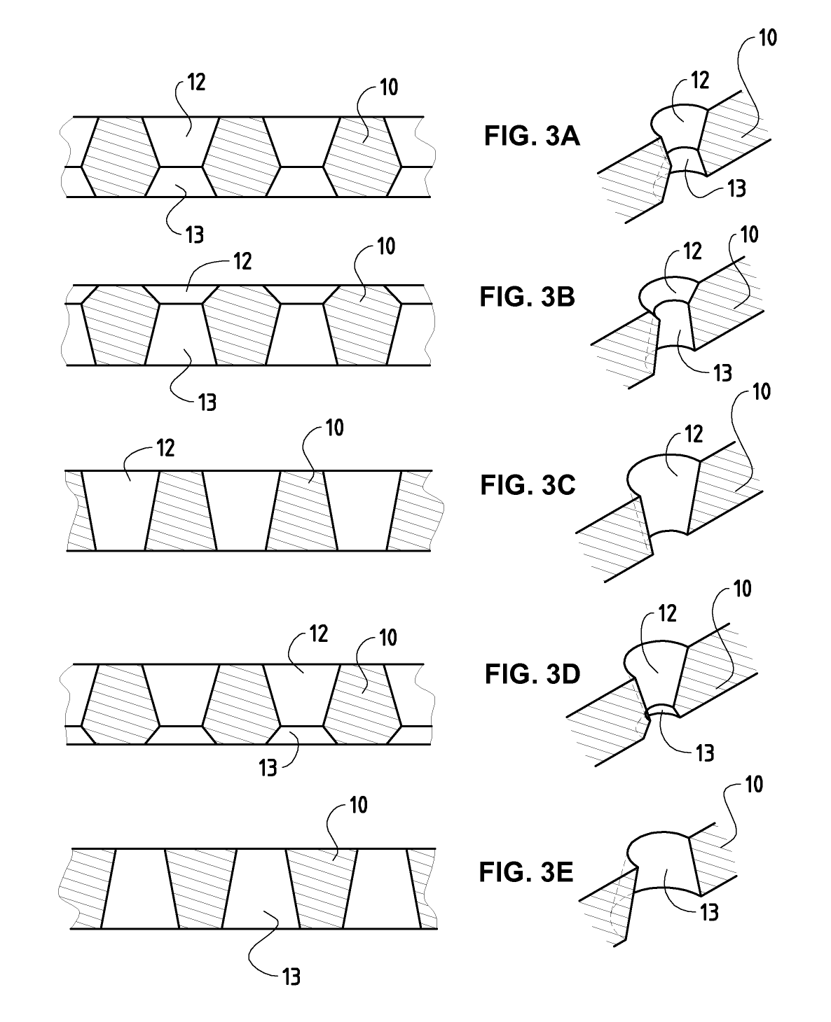

The etched profiled orifices of the invention may be etched as straight-through holes with parallel sides orthogonal to the filter plate 10. However, FIGS. 3A to 3E show some flared orifice geometries which offer advantages of easier cleaning and/or less clogging. In all cases in FIGS. 3A to 3E, the cutting fluid passes through the plate 10 from top to bottom. Flared upper portions 12 allow particles which lodge in the upper portion of the orifice to be easily brushed out by the brushes, wipers or scrapers which pass across the upper surface of the plate 10. Flared downward portions 13 ensure that any particles which pass through the narrowest (waist) region of the orifices can then travel freely through the lower part of the orifices. Etched orifices can be made significantly smaller and more evenly-shaped and -sized than perforations (mechanically stamped holes), and without burring. Perforations can be made down to 0.5 mm, while etched orifices can me made down to 0.2 mm or 0.1 mm. Mechanical perforation also entails the use of a thicker plate, while etched plates can be made much thinner (0.2 or 0.1 mm, for example). Thinner filter plates, having short through-holes than thicker plates, are also less likely to clog.

Profiled orifices, etched in arrays by photo etching or chemical milling, for example, permit much smaller apertures than are possible with mechanical perforations, and result in much finer filtration. In addition, the etching process enables a much closer distribution of the orifices in an array. In this way, it is possible to greatly increase the open proportion of the plate from a typical value of between 5% and 10% for a perforated plate to more than 18% for an etched plate. The maximum open proportion which is possible using mechanical perforations reduces as the perforations become smaller, so a trade-off between hole size and fluid flow is inevitable. Open proportions of etched plates, on the other hand, are not constrained by such a trade-off, and proportions as great as 40% are possible, even with orifice sizes of 0.2 mm or less. In this way, etched filter plates allow the fluid flow to be greatly increased, while the minimum filtered particle size is greatly decreased. At the same time, the filter plate has very flat, burr-free surfaces which can be smoothly and efficiently swept, wiped or scraped by the wiping elements on arranged on the inside of the conveyor belt.

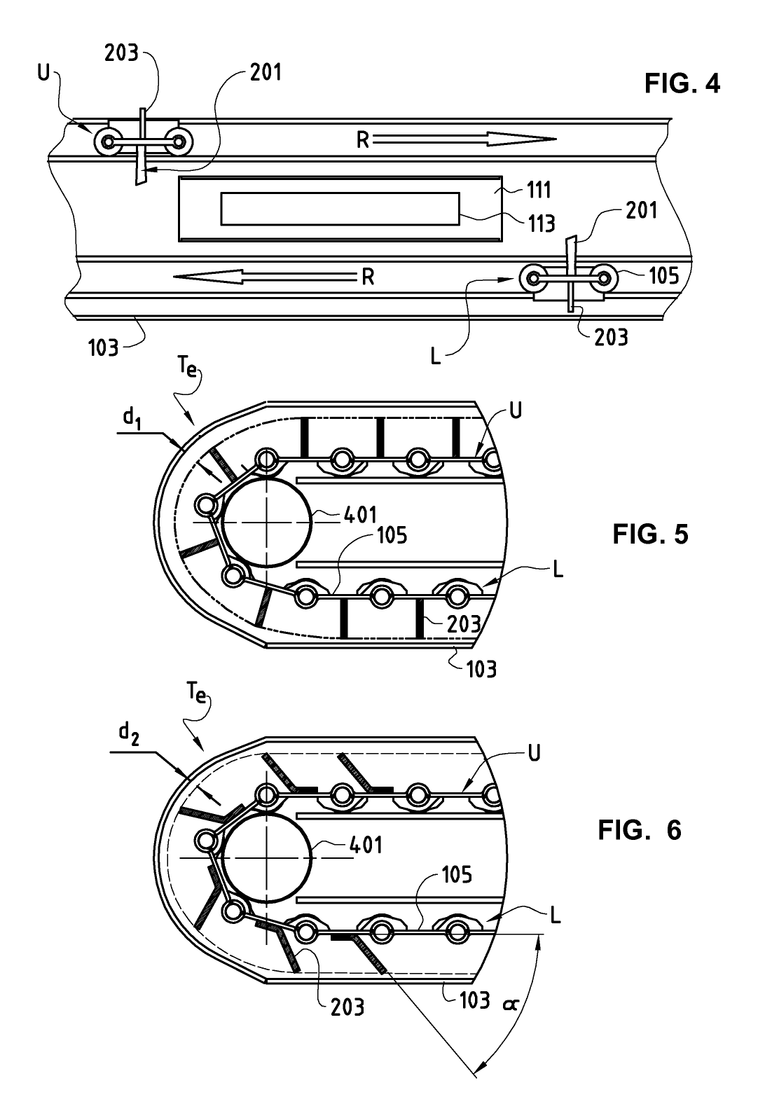

As illustrated in FIGS. 2, 4, 5, 6 and 8, there are provided cleaning means, in this example brushes 201, on the inner side of the belt 105 to clean the filter box 111 as the belt 105 rotates. Thus, the natural rotation of the belt 105 is used for cleaning the box 111. In this example, the brushes are made of nylon, and are placed in the middle of the flat metal part of the belt, i.e. the part between the hinges. It is also possible for the brushes to be made of other polymers and metals. The cleaning means could also be in the form of wiping blades to clear the filter box 111. Also it is possible that not every metal plate has the brushes.

In the embodiment illustrated there are also provided other cleaning means, such as rigid bars or cleats 203, on the outer surface of the belt 105 to clean the conveyor tank 103. The nature of the chips to sink to the bottom of the conveyor 100 also ensures that as the belt 105 rotates any small chips are automatically carried out of the conveyor 100 too. The cleats 203 are arranged so that they do not touch the conveyor tank 103 to prevent wear and tear. For instance, a space of a few millimeters could be left between the conveyor tank 103 and the cleats 203.

Different configurations for the cleats 203 are better illustrated in FIGS. 5 and 6. For the sake of simplicity, the brushes have been omitted in these figures. These figures are side views of the tail end Te of the conveyor 100. In FIG. 5, the cleats 203 that are made of metal in this example have an angle of 90 degrees with respect to the flat metal plate of the belt part that is between two hinges. In other words, the cleats 203 are perpendicular to the belt 105. However, as the cleats 203 are attached to the flat metal plate of the belt 105 between two hinges, the space does not remain constant between the conveyor tank 103 and the cleats 203 in the tail end of the conveyor tank 103 even if the tail part of the conveyor tank 103 is rounded. This can be clearly seen in FIG. 5, where the distance d1 between the cleat end and the conveyor tank 103 is greater in the tail end part of the conveyor 100, compared with the distance in the flat bottom part of the conveyor 100 due to the path taken by rigid hinge plates.

To overcome this problem, the cleats 203 can be bent or tilted backwards (when considered in the direction of rotation of the belt), as illustrated in FIG. 6. In this variant the cleats 203 have two straight parts with a predetermined angle between them. The cleats 203 thus form an angle a with respect to the flat plate of the belt 105, as illustrated by the figure. This angle can be, for example, in the range of 30-60 degrees, to keep the space between the conveyor tank 103 and the cleats 203 constant as far as possible. Here in the tail end Te the distance d2 between the cleat ends and the conveyor tank 103 remains constant, even around the curve. The first part of the cleats is used for attaching the cleat to the flat metal plate, and is therefore parallel to the metal plate. The second part is inclined with respect to the first part and thus forms an angle a with respect to the flat metal plate of the belt 105. In other words, the cleats (203) are angled in a way that the extreme end (protruding end) of the cleat (203) in the tail end (Te) is in line with the pivot point of the belt (105) to ensure this extreme end remains a fixed distance (d2) from the conveyor tank (103) in the tail end (Te). Other variants are also possible. For instance, the conveyor 100 may have both types of cleats 203.

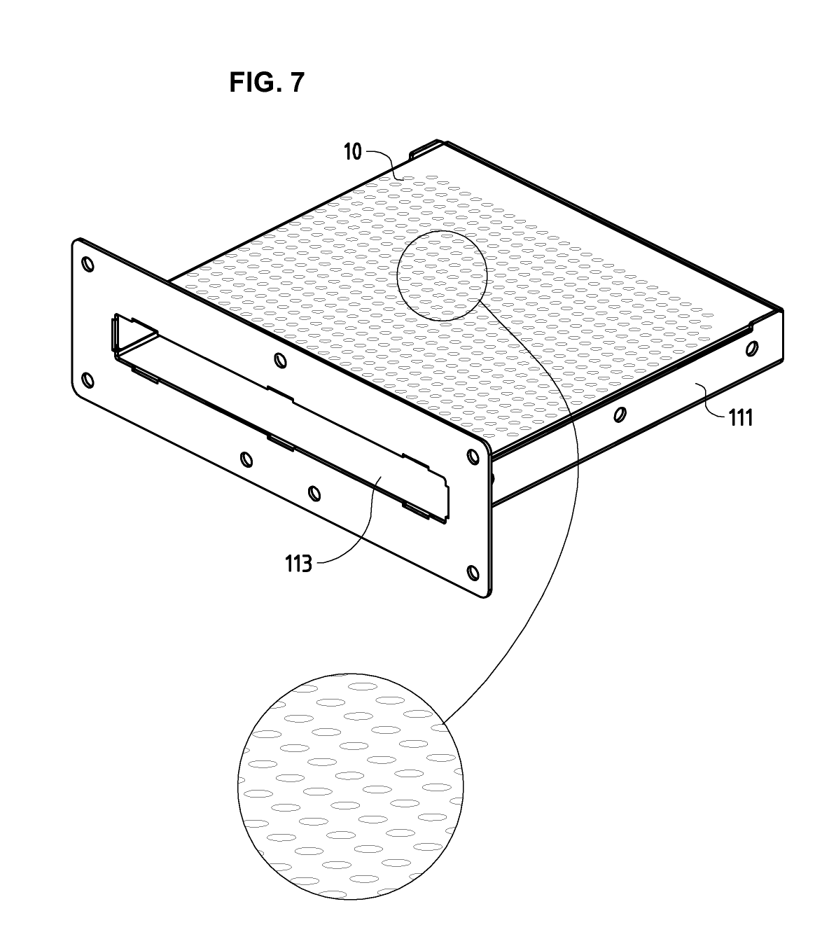

FIG. 7 is an exemplary perspective illustration of one possible filter box 111, shown the bottom side up. When in operational position, the filter box 111 has in this example four substantially vertical sides and two substantially horizontal ends, i.e. the bottom part and the top part. One of the side walls is a front panel, and has an opening 113 so that the filtered cutting fluid can be drained through this opening 113 to the clean cutting fluid container. The filter box could also incorporate more than one filtering opening. The box can also incorporate round ends/sloped faces, depending on specific applications.

In this example, the bottom part has a filtering screen or mesh 10 (i.e. filter plate screen) that is arranged to filter the dirty cutting fluid. The mesh is advantageously made of one of a variety of materials, including metals or plastics. The other sides of the box 111 are metal walls that do not allow the cutting fluid to penetrate into the box 111 through these walls. However, it is to be noted that the number of sides being fitted with the mesh 10is not limited to 1. Also, instead of the bottom side being fitted with the mesh 10, any other side could be equally fitted with the mesh 10.

In the above example, the filter box 111 has only one filter box 111. However, in other variants, the conveyor 100 may contain several filter boxes 111 located on the inside of the belt 105. The number and/or size of the boxes 111 depend(s) on the amount of cutting fluid used. In other words, if a considerable amount of cutting fluid is needed, then the number and/or size of the boxes 111 should be increased.

Above a filtering chip conveyor 100 was described in accordance with an embodiment of the present invention. In essence, in this embodiment the proposed conveyor 100 is a hinge belt conveyor with at least one filter box 111 incorporated therein and internal cleaning brushes or wipers 201 to clean the box(es) 111 automatically.

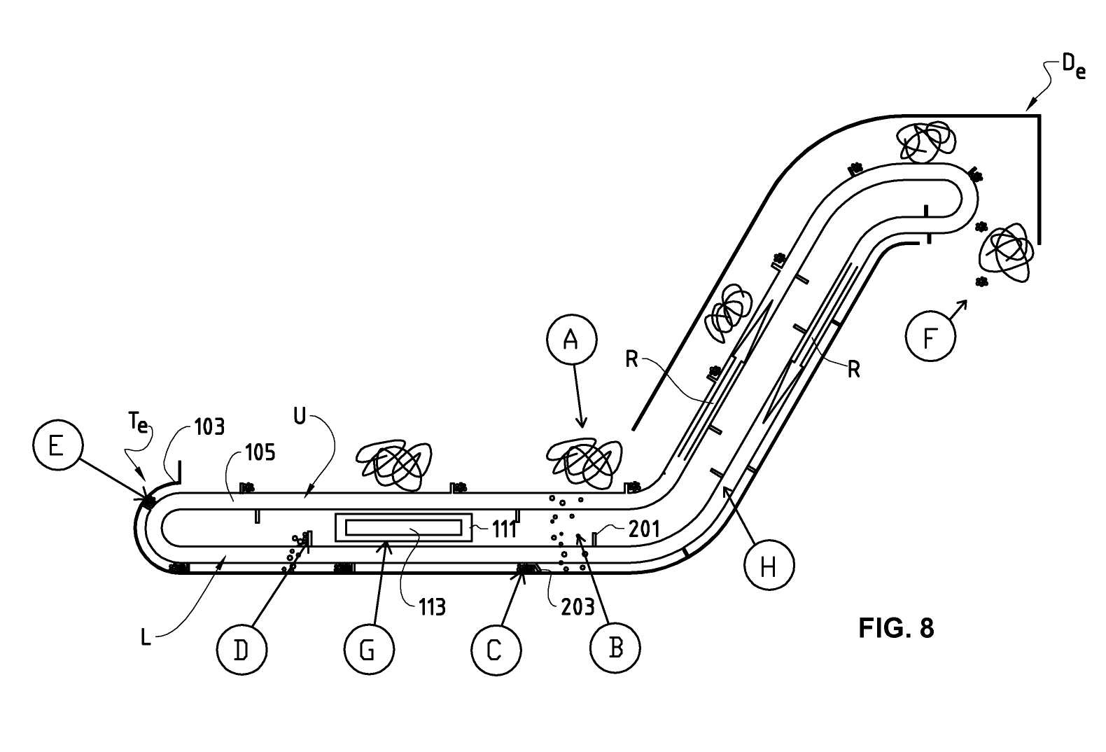

The operation of the conveyor 100 is explained next with reference to FIG. 8 using the same reference numerals as in the figure.
A. Large chips are stopped and taken out by the continuous hinge belt 105 on the outside surface of the belt 105.
B. Some small chips wash through or around the hinge belt 105 and fall to the bottom of the conveyor tank 103 over time.
C. The cleats 203 swipe the bottom surface of the conveyor 100 to gather any small chips that have fallen to the bottom of the conveyor tank 103.
D. Brushes or wiper bars 201 are used to wipe the filter box 111 as the belt 105 rotates. Any small chips that are wiped off by the brush/wiper 201 fall to the bottom of the conveyor tank 103, and are collected by the part described in C.
E. As the parts described in C rotate around the end of the conveyor 100, the small chips are held against the conveyor tank 103 of the conveyor 100 and lifted onto the top of the conveyor belt 105.
F. All chips are discharged from this part of the conveyor 100.
G. The filter box 111 contains at least one filtering screen 10 to filter all the cutting fluid as it passes through the box 111 and into the tank, ensuring only clean filtered cutting fluid can pass out of the conveyor 100. The filter box 111 is mounted between the upper and lower belt flights. As shown in the figure, the conveyor 100 has three flights: two horizontal flights and one inclined flight that connects the lower and upper level horizontal flights. In this example the bottom surface of the box 111 contains the filtering screen 10, so that the cutting fluid can enter the box 111 through the bottom while the level of the cutting fluid in the conveyor tank 103 increases. While in operation, the filter box 111 is at least partly disposed in the cutting fluid.

While the invention has been illustrated and described in detail in the drawings and foregoing description, such illustration and description are to be considered illustrative or exemplary and not restrictive, the invention being not restricted to the disclosed embodiment. Dual, triple or numerous filter screens 10in the same filter box 111 could be used. Layered filtration to finer and finer levels could also be considered. The filter boxes could be fixed to the tank 103. The box 111 could consist of one large box. Furthermore, the filter screen 10 could also form part of the tank 103 of the conveyor 100. Other variations of the disclosed embodiment can be understood and effected by those skilled in the art in practising the claimed invention, from a study of the drawings, the disclosure and the appended claims.

In the claims, the word “comprising” does not exclude other elements or steps, and the indefinite article “a” or “an” does not exclude a plurality. A single processor or other unit may fulfil the functions of several items recited in the claims. The mere fact that different features are recited in mutually different dependent claims does not indicate that a combination of these features cannot be advantageously used. Any reference signs in the claims should not be construed as limiting the scope of the invention.

1. A filtering chip conveyor comprising:
a conveyor tank arranged to retain cutting fluid containing chips,
a continuous conveyor belt at least partly disposed inside the conveyor tank, the belt being arranged to rotate and to turn at a tail end and at a discharge end, with a space between upper and lower flights of the belt, so as to transport chips on the upper flight towards the discharge end, to be discharged off the conveyor,
at least one filter box arranged between the upper and the lower flights of the belt,
at least one filter plate arranged in the filter box, the filter plate comprising a filtration region having a plurality of openings for permitting cutting fluid to pass through the filter plate while not permitting chips whose smallest sectional chip dimension is larger than a predetermined maximum chip dimension, to pass through the filter plate,
wherein:
the at least one filter plate has a thickness of less than 0.3 mm,
the openings include an array of profiled orifices etched through the filter plate, the etched orifice profile being such that the smallest sectional aperture dimension of each orifice is less than 0.3 mm, and such that the sum of the aperture areas of the orifices in the array is at least 18% of the total plate area of the array.

2. A conveyor according to claim 1, wherein at least one of the at least one filter plates is arranged in an upper surface and/or in a lower surface of the filter box.

3. A conveyor according to claim 1, wherein the filter plate is retained in a frame for maintaining the filter plate under lateral tension.

4. A conveyor according to claim 1, wherein each of the etched profiled orifices has a straight-through profile, substantially orthogonal to the plane of the filter plate, over at least a portion of the thickness of the filter plate.

5. A conveyor according to claim 1, wherein each of the etched profiled orifices has a flared profile portion, flaring from a waist region of minimum aperture area to one of the filter plate surfaces, over at least a portion of the thickness of the filter plate.

6. A conveyor according to claim 5, wherein the waist region is located in a plane intermediate to the thickness of the filter plate.

7. A conveyor according to claim 6, wherein the plane of the waist region is at the surface of the filter plate which faces outward from the filter box.

8. A conveyor according to claim 6, wherein the plane of the waist region is at the surface of the filter plate which faces inwards into the filter box.

9. A conveyor according to claim 1, wherein the belt further comprises at least one wiping element arranged to wipe across the filter plate as the belt rotates.

10. A conveyor according to claim 1, further comprising backwashing means for inducing a flow of cutting fluid through the profiled orifices in a direction counter to the direction of flow of the cutting fluid through the orifices during filtering.

11. A conveyor according to claim 10, wherein the backwashing means comprises a positive pressure generating means for increasing the pressure at the orifices of cutting fluid within the filter box to be greater than the pressure of cutting fluid outside the filter box.

12. A conveyor according to claim 10, wherein the backwashing means is adapted to induce one or more positive pressure pulses in the cutting fluid within the filter box such that a backwashing of the orifices is achieved without significantly interrupting the flow of cutting fluid in the filtration direction.

13. A method of removing chips from a cutting fluid using a filtering chip conveyor,
the filtering chip conveyor comprising a conveyor tank arranged to retain the cutting fluid containing chips, a continuous conveyor belt at least partly disposed inside the conveyor tank, and a filter box arranged between upper and lower flights of the belt such that upper and/or lower surfaces of the filter box are wiped by at least one wiper element arranged on the inside of the continuous conveyor belt, the filter box being provided with a filter plate having a thickness of less than 0.3 mm, the filter plate being arranged to be wiped by the said wiper elements,
the step of providing the filter plate including a step of photo-etching or chemically milling an array of profiled orifices in the filter plate, such that the etched profiled orifices each have a minimum aperture dimension of less than 0.3 mm, and such that the sum of the aperture areas of the orifices in the array is at least 18% of the total plate area of the array.

14. A method according to claim 13, comprising a step of mounting the filter plate to the filter box such that the filter plate is held in tension when the filter plate is wiped by the wiper elements.

15. A conveyor according to claim 1, wherein the etched profiled orifices have a minimum aperture dimension of between 0.1 and 0.2 mm, and the filter plate has a thickness of between 0.1 and 0.2 mm.
